(19) United States
(12) Patent Application Publication
(10) Pub. No.: US 2025/0363555 A1
(43) Pub. Date: Nov. 27, 2025

(54) APPARATUS AND METHOD FOR FORMULATING BIDDING STRATEGY BASED ON PHOTOVOLTATIC POWER GENERATION

(71) Applicant: HANWHA SOLUTIONS CORPORATION, Seoul (KR)

(72) Inventors: Jung Woo SEO, Seoul (KR); Dong-Hyun KIM, Seoul (KR); Sang Woo SHIM, Seoul (KR)

(73) Assignee: HANWHA SOLUTIONS CORPORATION, Seoul (KR)

(21) Appl. No.: 19/202,358

(22) Filed: May 8, 2025

(30) Foreign Application Priority Data
May 22, 2024 (KR) 10-2024-0066722

(51) Int. Cl. G06Q 40/04; G06Q 30/0202; G06Q 50/06

(52) U.S. Cl. CPC G06Q 40/04; G06Q 30/0202; G06Q 50/06

(57) ABSTRACT

Provided is an apparatus for formulating a bidding strategy based on photovoltaic power generation, the apparatus including at least one processor and at least one memory operably connected to the processor, wherein the at least one processor is further configured to collect electricity market operation data, construct a simulation algorithm based on the electricity market operation data, generate at least one bid candidate from at least one power generation forecast scenario derived based on a day-ahead forecasted power generation, derive value at risk (VaR) based on the simulation algorithm and the bid candidate, and determine forecasted power generation satisfying a preset condition as day-ahead bid quantity, from a result of deriving the VaR.

### CROSS-REFERENCE TO RELATED APPLICATION

This application is based on and claims priority under 35 USC § 119 to Korean Patent Application No. 10-2024-0066722, May 22 filed on, 2024, in the Korean Intellectual Property Office, the disclosure of which is incorporated by reference herein in its entirety.

### BACKGROUND

### 1. Field

The disclosure relates to an apparatus and method for formulating a bidding strategy based on photovoltaic power generation.

### 2. Description of the Related Art

The modern electricity market faces the challenge of integrating various energy sources while also dealing with a high level of market-based price volatility. In particular, renewable energy sources such as photovoltaic power generation are subject to significant output fluctuations due to environmental factors, which can affect price determination and supply planning in the electricity market. Such volatility increases the unpredictability of the electricity market and may add complexity to power trading and economic risk management. To effectively manage the uncertainty of photovoltaic power generation, electricity market participants must optimize power generation forecasting, bidding price setting, and risk management strategies.

The aforementioned background technology consists of technical information that the inventors either possessed for deriving the present disclosure or acquired during its development process. Therefore, it cannot necessarily be considered publicly known technology that was disclosed to the general public prior to the filing of the present application.

### SUMMARY

One objective of the disclosure is to formulate a bidding strategy for the electricity market by utilizing photovoltaic power generation data so that electricity market participants can minimize economic risks and maintain competitiveness while effectively managing the volatility of photovoltaic power generation.

The objective of the exemplary embodiment of the disclosure is not limited to the above-mentioned objective and other objectives and advantages of the disclosure which have not been mentioned above may be understood by the following description and become more apparent from exemplary embodiments of the disclosure. Furthermore, it will be understood that aspects and advantages of the disclosure may be achieved by the means set forth in claims and combinations thereof.

In one general aspect, there is provided an apparatus for formulating a bidding strategy based on photovoltaic power generation, the apparatus including at least one processor and at least one memory operably connected to the processor, wherein the at least one processor is further configured to collect electricity market operation data including one or more of a day-ahead system marginal price, a real-time system marginal price, a day-ahead forecasted power generation made on a previous day for a next day, and a real-time forecasted power generation, construct a simulation algorithm based on the electricity market operation data, generate at least one bid candidate from at least one power generation forecast scenario derived based on the day-ahead forecasted power generation, derive value at risk (VaR) based on the simulation algorithm and the bid candidate, and determine forecasted power generation satisfying a preset condition as day-ahead bid quantity, based on a result of deriving the VaR.

In another general aspect, there is provided a method for formulating a bidding strategy based on photovoltaic power generation, the method including collecting electricity market operation data including at least one of a day-ahead system marginal price, a real-time system marginal price, a day-ahead forecasted power generation made on a previous day for a next day, and a real-time forecasted power generation, constructing a simulation algorithm based on the electricity market operation data, generating at least one bid candidate from at least one power generation forecast scenario derived based on the day-ahead forecasted power generation, deriving value at risk (VaR) based on the simulation algorithm and the bid candidate, and determining forecasted power generation satisfying a preset condition as day-ahead bid quantity based on a result of deriving the VaR.

In addition, other methods and systems for implementing the present disclosure, and a computer-readable recording medium having recorded thereon a computer program for executing the methods may be further provided.

Other aspects, features, and advantages other than those described above will be apparent from the following drawings, claims, and detailed description.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a block diagram schematically illustrating the configuration of an apparatus for formulating a bidding strategy based on photovoltaic power generation according to an embodiment;

FIG. 2 is a waveform diagram for explaining a generation unit of the apparatus for formulating a bidding strategy shown in FIG. 1;

FIG. 3 is a table for explaining a determination unit of the apparatus formulating a bidding strategy shown in FIG. 1;

FIG. 4 is a block diagram schematically illustrating the configuration of an apparatus for formulating a bidding strategy based on photovoltaic power generation according to another embodiment; and

FIGS. 5 and 6 are flowcharts illustrating a method for formulating a bidding strategy based on photovoltaic power generation according to an embodiment.

### DETAILED DESCRIPTION

Advantages and features of the disclosure and methods for achieving them will become apparent from the descriptions of aspects herein below with reference to the accompanying drawings. However, the description of particular example embodiments is not intended to limit the disclosure to the particular example embodiments disclosed herein, but on the contrary, it should be understood that the present disclosure is to cover all modifications, equivalents and alternatives falling within the spirit and scope of the disclosure. The example embodiments disclosed below are provided so that the disclosure will be thorough and complete, and also to provide a more complete understanding of the scope of the disclosure to those of ordinary skill in the art. In the interest of clarity, not all details of the relevant art are described in detail in the present specification in so much as such details are not necessary to obtain a complete understanding of the disclosure.

The terminology used herein is used for the purpose of describing particular example embodiments only and is not intended to be limiting. The singular forms “a,” “an,” and “the” may be intended to include the plural forms as well, unless the context clearly indicates otherwise. It should be understood that the terms “comprises,” “comprising,” “including,” and “having,” as used herein, are inclusive and therefore specify the presence of stated features, integers, steps, operations, elements, and/or components, but do not preclude the presence or addition of one or more other features, integers, steps, operations, elements, components, and/or groups thereof. It will be understood that although the terms “first,” “second,” etc., may be used herein to describe various components, these components should not be limited by these terms. These terms are only used to distinguish one component from another.

Furthermore, the term “unit” as used herein may refer to a hardware component, such as a processor or a circuit, and/or a software component executed by a hardware component such as a processor.

Hereinafter, various embodiments of the disclosure will be described below in more detail with reference to the accompanying drawings. Those components that are the same or are in correspondence are rendered the same reference numeral regardless of the figure number, and redundant explanations are omitted.

In the embodiments described below, the terms “first,” “second,” etc. are not used in a limiting sense but are used for the purpose of distinguishing one component from another.

In the embodiments described below, the singular forms may be intended to include the plural forms as well, unless the context clearly indicates otherwise.

In the embodiments described below, the terms “include” or “have” are merely intended to indicate that stated features or components are present, and are not intended to exclude the possibility that one or more other features or components will be present or added.

When some example embodiments may be embodied otherwise, respective process steps described herein may be performed otherwise. For example, two process steps described in a sequential order may be performed around the same time, or in reverse order.

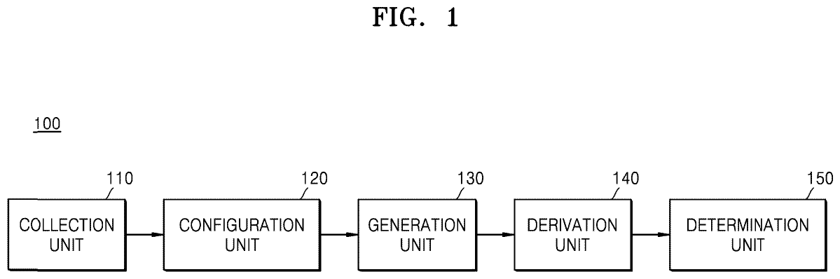

FIG. 1 is a block diagram schematically illustrating the configuration of an apparatus for formulating a bidding strategy based on photovoltaic power generation according to an embodiment.

Referring to FIG. 1, an apparatus 100 for formulating a bidding strategy based on photovoltaic power generation (hereinafter referred to as a bidding strategy formulation apparatus) may include a collection unit 110, a configuration unit 120, a generation unit 130, a derivation unit 140, and a determination unit 150.

The collection unit 110 may collect electricity market operation data from an external source. In an embodiment, the electricity market operation data may include one or more of a day-ahead system marginal price (DA SMP), a real-time system marginal price (RT SMP), a day-ahead forecasted power generation (DA GEN), and a real-time forecasted power generation (RT GEN).

The collection unit 110 may collect the day-ahead system marginal price (DA SMP) and the real-time system marginal price (RT SMP) from a power exchange or an electricity market operator. In an embodiment, in a day-ahead electricity market, electricity prices are determined based on forecasts of power demand and supply for the next day and may be set through a bidding process hosted by a power exchange. The power exchange typically accepts bids one day in advance to match the next day's electricity demand and supply, and based on the bidding results, it may calculate the day-ahead system marginal price (DA SMP). This process provides electricity market participants with an opportunity to predict the next day's electricity prices and demand, helping them establish power generation and electricity procurement plans in advance. The day-ahead system marginal price (DA SMP) is publicly available through the power exchange's website, specialized data services, or APIs, allowing the electricity market participants to access this information. Additionally, the real-time system marginal price (RT SMP) is determined based on real-time fluctuations in electricity demand and supply and may reflect data related to the operating status of a power grid. The power exchange provides a platform for real-time electricity trading, and the transaction prices generated through this platform may be set as the real-time system marginal price (RT SMP).

The collection unit 110 may collect the day-ahead forecasted power generation (DA GEN) and the real-time forecasted power generation (RT GEN) from the power exchange or the power grid operator. In another embodiment, the collection unit 110 may collect the day-ahead forecasted power generation (DA GEN) and the real-time forecasted power generation (RT GEN) from a power generation company.

The configuration unit 120 may construct a simulation algorithm based on the electricity market operation data received from the collection unit 110.

The configuration unit 120 may construct a first simulation algorithm (SMP DA simulation) based on the day-ahead system marginal price (DA SMP). In an embodiment, the configuration unit 120 may construct the first simulation algorithm (SMP DA simulation), as expressed in Equation 1 below.

$$S M P D A Simulation = \frac{1}{{σ}_{DA SMP} \sqrt{2 π}} {e}^{- \frac{1}{2} {( \frac{x - {μ}_{DA SMP}}{{σ}_{DA SMP}} )}^{2}} \qquad [ Equation 1 ]$$

$${μ}_{DA SMP} = \frac{{\sum }_{i = 1}^{N} D A S M {P}_{i}}{N}$$

$${σ}_{DA SMP} = \sqrt{\frac{{\sum }_{i = 1}^{N} {( D A S M {P}_{i} - {μ}_{DA SMP} )}^{2}}{N}}$$

In Equation 1, DA SMP represents the day-ahead system marginal price, and i denotes the number of simulation iterations, that is, the number of bid candidates, as will be described below.

The configuration unit 120 may construct a second simulation algorithm (SMP RT simulation) based on the execution results of the first simulation algorithm (SMP DA simulation), the DA SMP, and the RT SMP. In an embodiment, the configuration unit 120 may construct the second simulation algorithm (SMP RT simulation), as expressed in Equation 2 below.

$$S M P R T Simulation = S M P D A Simulation + \frac{1}{{σ}_{DA Delta} \sqrt{2 π}} {e}^{- \frac{1}{2} {( \frac{x - {μ}_{SMP Delta}}{{σ}_{SMP Delta}} )}^{2}} \qquad [ Equation 2 ]$$

$$S M P Delta = R T S M P - D A S M P$$

$${μ}_{SMP Delta} = \frac{{\sum }_{i = 1}^{N} S M P {Delta}_{i}}{N}$$

$${σ}_{SMP Delta} = \sqrt{\frac{{\sum }_{i = 1}^{N} {( S M P {Delta}_{i} - {μ}_{SMP Delta} )}^{2}}{N}}$$

In Equation 2, SMP DA simulation represents the execution result of the first simulation algorithm, DA SMP represents the day-ahead system marginal price, RT SMP represents the real-time system marginal price, and i may denote the number of simulation iterations, that is, the number of bid candidates, as will be described below.

The configuration unit 120 may construct a third simulation algorithm (Gen RT simulation) based on the day-ahead forecasted power generation (DA GEN) and the real-time forecasted power generation (RT GEN). In an embodiment, the configuration unit 120 may construct the third simulation algorithm (Gen RT simulation), as expressed in Equation 3 below.

$$Gen R T Simulation = Gen Expected \times ( 1 + \frac{1}{{σ}_{Gen Ratio} \sqrt{2 π}} {e}^{- \frac{1}{2} {( \frac{x - {μ}_{Gen Ratio}}{{σ}_{Gen Ratio}} )}^{2}} ) \qquad [ Equation 3 ]$$

$$Gen Ratio = \frac{R T GEN}{D A GEN} - 1$$

$${μ}_{Gen Ratio} = \frac{{\sum }_{i = 1}^{N} Gen {Ratio}_{i}}{N}$$

$${σ}_{Gen Ratio} = \sqrt{\frac{{\sum }_{i = 1}^{N} {( Gen {Ratio}_{i} - {μ}_{Gen Ratio} )}^{2}}{N}}$$

In Equation 3, Gen Expected represents forecasted power generation, RT GEN represents the real-time forecasted power generation, DA GEN represents the day-ahead generation, forecasted on the previous day for the next day, and i denotes the number of simulation iterations, that is, the number of bid candidates, as will be described below.

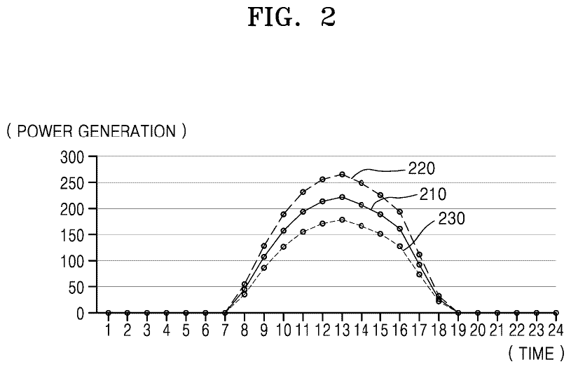

The generation unit 130 may generate at least one bid candidate from at least one power generation forecast scenario, which is derived based on the day-ahead forecasted power generation. FIG. 2 is a waveform diagram for explaining the generation unit of the bidding strategy formulation apparatus shown in FIG. 1.

The generation unit 130 may load the day-ahead forecasted power generation (DA GEN) 210, which includes power generation for each time period throughout a day. Referring to the day-ahead forecasted power generation (DA GEN) 210 according to the embodiment shown in FIG. 2, since it is based on photovoltaic generation, the power generation may be zero from 1:00 AM to 7:00 AM as well as from 7:00 PM to 12:00 AM due to the absence of sunlight. Additionally, in the graph representing the day-ahead forecasted power generation (DA GEN) 210 according to the embodiment shown in FIG. 2, the X-axis represents the time period, while the Y-axis represents the power generation. In an embodiment, the day-ahead generation 210 shown in FIG. 2 may be baseline power generation.

The generation unit 130 may receive a forecast range for power generation and a bid candidate extraction interval (width). In an embodiment, the forecast range may represent a fluctuation range of power generation, and the extraction interval may represent a width of a segment within the fluctuation range.

The generation unit 130 may generate at least one power generation forecast scenario by applying the forecast range to the day-ahead forecasted power generation. For example, when the baseline power generation is 100 and a received forecast range is 0.2, the fluctuation range would be 20 (baseline power generation 100×forecast range 0.2). The generation unit 130 may generate a first power generation forecast scenario 220 representing 80% of the day-ahead forecasted power generation (DA GEN) 210 (baseline power generation) and a second power generation forecast scenario 230 representing 120% of the day-ahead forecasted power generation (DA GEN) 210 (baseline power generation).

The generation unit 130 may extract at least one bid candidate corresponding to the extraction interval from the power generation forecast scenarios. For example, when the received extraction interval (width) is 0.1, the width of each segment of the bid candidate would be 2 (fluctuation range 20×extraction interval (width) 0.1). From this, the width of the bid candidate may be extracted in units of 2.

The generation unit 130 may extract at least one bid candidate corresponding to the extraction interval from the power generation forecast scenario. According to the example described above, the generation unit 130 may extract at least one bid candidate with a width in units of 2, using the first power generation forecast scenario 220 as a starting point and the second power generation forecast scenario 230 as an endpoint.

The generation unit 130 may obtain the time period and forecasted power generation that are matched to the at least one extracted bid candidate.

The derivation unit 140 may derive value at risk (VaR) satisfying a preset confidence level, based on the simulation algorithms and the bid candidates.

The derivation unit 140 may calculate a day-ahead forecasted revenue (Gen DA Revenue) using a first risk prediction algorithm, which is generated based on the time period and forecasted power generation that are matched to the bid candidate, the number of bid candidates, and the first simulation algorithm (SMP DA simulation). In an embodiment, the derivation unit 140 may calculate the day-ahead forecasted revenue (Gen DA Revenue) using the first risk prediction algorithm, as expressed in Equation 4 below.

$$Gen D A Revenue = Offer Candidate ( Candidate Index ) * S M P D A Simulation \qquad [ Equation 4 ]$$

The derivation unit 140 may calculate a real-time forecasted revenue (Gen RT Settlement) using a second risk prediction algorithm, which is generated based on the time period and forecasted power generation that are matched to the bid candidate, the number of bid candidates, the second simulation algorithm (SMP RT simulation), and the third simulation algorithm (GEN RT simulation). In an embodiment, the derivation unit 140 may calculate the real-time forecasted revenue (Gen RT Settlement) using the second risk prediction algorithm, as expressed in Equation 5 below.

$$Gen R T Settlement = S M P R T Simulation * \{ GEN R T Simulation - Offer Candidate ( Candidate Index ) \}$$

The derivation unit 140 may calculate the total profit (Gen Profit) using a third risk prediction algorithm, which is generated based on the day-ahead forecasted revenue (Gen DA Revenue) and the real-time forecasted revenue (Gen RT Settlement). In an embodiment, the derivation unit 140 may calculate the total profit (Gen Profit) using the third risk prediction algorithm, as expressed in Equation 6 below.

$$Gen Profit = Gen D A Revenue + Gen R T Settlement \qquad [ Equation 6 ]$$

The derivation unit 140 may calculate a loss (Gen Loss) using a fourth risk prediction algorithm generated based on the total profit (Gen Profit). In an embodiment, the derivation unit 140 may calculate the loss (Gen Loss) using the fourth risk prediction algorithm, as expressed in Equation 7 below.

$$Gen Loss = - ( Gen D A Revenue + Gen R T Settlement ) \qquad [ Equation 7 ]$$

The derivation unit 140 may derive VaR by extracting the loss (Gen Loss) that satisfies a preset confidence level from the results of calculating the loss (Gen Loss).

Utilizing VaR in formulating a bidding strategy in the electricity market may play a crucial role in predicting the maximum loss that may occur over a specific period. For example, a bidder in the electricity market may use VaR when determining the bid value by taking into account electricity price fluctuations and uncertainty in power generation for the next day. In an embodiment, in case that VaR is calculated for a confidence level of 80% as received from a bidder, the total profit (Gen Profit) and a loss (Gen Loss) may be calculated using Equations 4 through 7, and the top 20% of the losses may be extracted. Here, the top 20% of losses may correspond to the VaR that satisfies the 80% confidence level.

The determination unit 150 may determine the forecasted power generation satisfying preset conditions as the day-ahead bid quantity based on the result of deriving the VaR, which corresponds to the loss (Gen Loss) that satisfies the preset confidence level.

The determination unit 150 may sort the results of deriving VaR in chronological order (by hour). The determination unit 150 may identify the bid candidate with the minimum VaR based on the VaR derived for each time period. The determination unit 150 may obtain the forecasted power generation corresponding to the bid candidate with the minimum VaR for each time period. The determination unit 150 may determine the result of aggregating the obtained forecasted power generation as the day-ahead bid quantity.

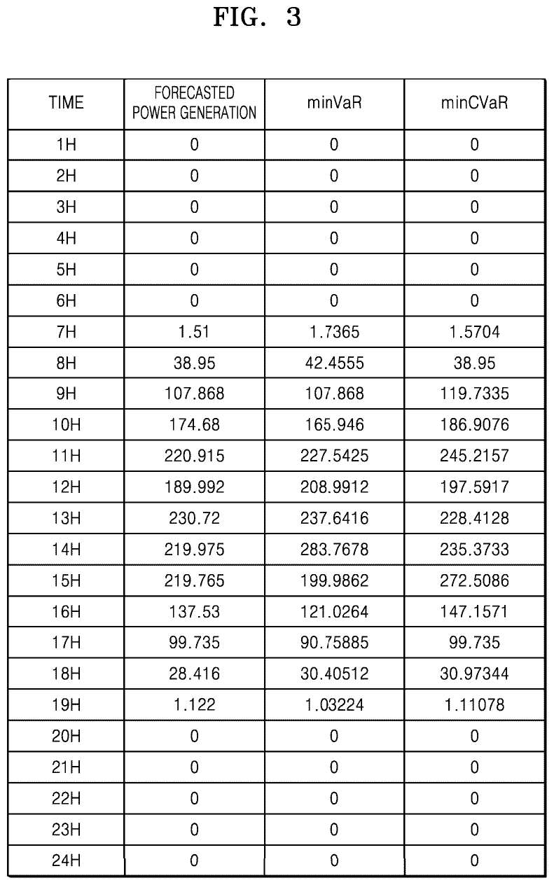

FIG. 3 is a table for explaining the determination unit of the bidding strategy formulation apparatus shown in FIG. 1. Referring to FIG. 3, the first column of the table represents time (0:00 to 24:00), the second column represents the day-ahead forecasted power generation for each time period, conducted on the previous day, the third column represents the forecasted power generation matched to the bid candidate with the minimum VaR for each time period at a preset confidence level, and the fourth column represents the forecasted power generation matched to the bid candidate with the minimum conditional value at risk (minCVaR) for each time period at the preset confidence level. In an embodiment, the forecasted power generation with the minimum VaR for each time period, shown in the third column, may be determined as bid quantity.

In FIG. 3, minCVaR represents the minimum value of conditional value at risk (CVaR) and may indicate the average value of losses that exceed the expected maximum loss at the preset confidence level. CVaR is a more conservative risk measurement tool than VaR. While VaR only indicates the probability of incurring a loss beyond a certain amount, CVaR may provide the expected average loss amount when such a loss occurs. For example, in case that VaR at a 95% confidence level is 1 billion KRW, this means that there is a 5% probability of incurring a loss of 1 billion KRW or more in a single day. In this case, minCVaR may represent the average of loss amounts that exceed the 1 billion KRW with a 5% probability.

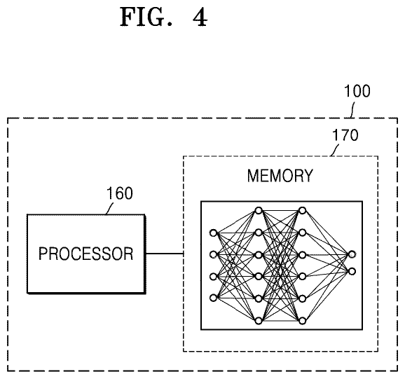

FIG. 4 is a block diagram schematically illustrating the configuration of an apparatus for formulating a bidding strategy based on photovoltaic power generation according to another embodiment In the following description, redundant descriptions overlapping with the descriptions of FIGS. 1 to 3 will not be reiterated. Referring to FIG. 4, a bidding strategy formulation apparatus 100 according to another embodiment may include a processor 160 and a memory 170.

In an embodiment, the processor 160 may process the functions performed by the collection unit 110, the configuration unit 120, the generation unit 130, the derivation unit 140, and the determination unit 150 disclosed in FIGS. 1 to 3.

The processor 160 may control the overall operation of the bidding strategy formulation apparatus 100. Here, the “processor” may, for example, refer to a data processing device embedded in hardware, which has a physically structured circuitry to perform a function represented by codes or instructions contained in a program. As examples of the data processing device embedded in hardware, a microprocessor, a central processing unit (CPU), a processor core, a multiprocessor, an application-specific integrated circuit (ASIC), and a field programmable gate array (FPGA) may be included, but the scope of the disclosure is not limited thereto.

The memory 170 is operably connected to the processor 160 and may store at least one code in relation to the operations performed by the processor 160.

Additionally, the memory 170 may perform a function of temporarily or permanently storing data processed by the processor 160. Here, the memory 170 may include a magnetic storage medium or a flash storage medium, but the scope of the disclosure is not limited thereto. Such memory 170 may include internal memory and/or external memory, and may include: a volatile memory such as a dynamic random-access memory (DRAM), static random-access memory (SRAM), or synchronous dynamic random-access memory (SDRAM); a non-volatile memory such as a one-time programmable read-only memory (OTPROM), PROM, erasable programmable ROM (EPROM), electrically erasable programmable ROM (EEPROM), mask ROM, flash ROM, NAND flash memory, or NOR flash memory; a flash drive such as a solid-state drive (SSD), compact flash (CF) card, secure digital (SD) card, micro-SD card, mini-SD card, xD card, or a memory stick; and a storage device such as an HDD.

In an embodiment, the processor 160 may use an artificial intelligence (AI) algorithm to formulate a bidding strategy. Here, artificial intelligence (AI) refers to a field of computer engineering and information technology that studies methods to enable computers to perform reasoning, learning, self-development, and the like, which are typically associated with human intelligence, and may refer to a process of allowing computers to mimic intelligent human behavior. In addition, AI does not exist on its own, but is rather directly or indirectly related to a number of other fields in computer science. In recent years, extensive attempts are being made to introduce AI elements into various fields of information technology to address problems in those fields. Machine learning is a subfield of AI that includes the field of research on giving computers the ability to learn without being explicitly programmed. Specifically, machine learning may refer to a technique for researching and establishing systems that learn from empirical data, make predictions, and autonomously improve their own performance, as well as the algorithms therefor. The algorithms in machine learning may take a way of building specific models to derive predictions or decisions based on input data, rather than performing strictly defined static program instructions. Both unsupervised learning and supervised learning methods may be employed as machine learning methods for artificial neural networks. Additionally, deep learning, which is a subfield of machine learning, enables data-based learning through multiple layers. As the number of layers in deep learning increases, the deep learning network may acquire a collection of machine learning algorithms that extract key data from multiple pieces of data.

The processor 160 may collect various data from external sources to generate the day-ahead forecasted power generation (DA GEN). Here, the various data may include one or more of the following: day-ahead power demand forecast data for the relevant region, generator characteristic data, and system constraint data. Additionally, the processor 160 may collect date data, weather data, and historical power demand data to generate the day-ahead power demand forecast data for the relevant region.

The processor 160 may analyze the date data, weather data, and historical power demand data to generate the day-ahead power demand forecast data for the relevant region. The processor 160 may generate the day-ahead power demand forecast data for the relevant region corresponding to the date data, weather data, and historical power demand data by using a first deep neural network model that generates the day-ahead power demand forecast data for the relevant region based on the date data, weather data, and historical power demand data. Here, the first deep neural network model may be a supervised learning-based model trained using first training data, where the input consists of date data, weather data, and historical electricity demand data for the relevant region and the label consists of day-ahead power demand data for the relevant region.

The processor 160 may train the initially set first deep neural network model using labeled first training data in a supervised learning manner. Here, the initially set first deep neural network model is an initial model designed to be configured as a model capable of predicting the day-ahead power demand data for the relevant region based on date data, weather data, and historical power demand data for the relevant region, and its parameter values may be set to arbitrary initial values. As the initial model is trained using the aforementioned first training data, its parameter values are optimized, enabling it to be completed as a first prediction model capable of accurately forecasting the day-ahead power demand data for the relevant region based on the date data, weather data, and historical power demand data of the relevant region.

The processor 160 may analyze the day-ahead power demand forecast data, the generator characteristic data, and the system constraint data for the relevant region to generate the day-ahead forecasted power generation of the relevant region. In an embodiment, the generator characteristic data for the relevant region may include generation cost data and generator bidding data. In an embodiment, the system constraint data for the relevant region may include operating reserve data and system-constrained operating generator data.

The processor 160 may generate the day-ahead forecasted power generation of the relevant region, corresponding to the day-ahead power demand forecast data, generator characteristic data, and system constraint data of the relevant region by using a second deep neural network model that generates the day-ahead forecasted power generation of the relevant region based on day-ahead power demand forecast data, generator characteristic data, and system constraint data of the relevant region. Here, the second deep neural network model may be a supervised learning-based model trained using second training data, where the input consists of day-ahead power demand forecast data, generator characteristic data, and system constraint data of the relevant region and the label consists of day-ahead power generation of a generator installed on the relevant region.

The processor 160 may train the initially configured set second deep neural network model using the labeled second training data in a supervised learning manner. Here, the initially configured set second deep neural network model is an initial model designed to be configured as a model capable of forecasting the day-ahead power generation in the relevant region from the day-ahead power demand forecast data, generator characteristic data, and system constraint data of the relevant region, and its parameter values may be set to arbitrary initial values. As the initial model is trained using the aforementioned second training data, its parameter values are optimized, enabling it to be completed as a second prediction model capable of accurately forecasting the day-ahead power generation in the relevant region based on the generator characteristic data and system constraint data of the relevant region.

The processor 160 may predict the day-ahead bid quantity for each time period by analyzing the day-ahead system marginal price (DA SMP), the real-time system marginal price (RT SMP), the day-ahead forecasted power generation (DA GEN), and the real-time forecasted power generation (RT GEN).

The processor 160 may predict the day-ahead bid quantity for each time period in the relevant region corresponding to the day-ahead system marginal price (DA SMP), the real-time system marginal price (RT SMP), the day-ahead forecasted power generation (DA GEN), and the real-time forecasted power generation (RT GEN) of the relevant region by using a third deep neural network model that forecasts the day-ahead bid quantity for each time period in the relevant region based on the day-ahead system marginal price (DA SMP), the real-time system marginal price (RT SMP), the day-ahead forecasted power generation (DA GEN), and the real-time forecasted power generation (RT GEN) of the relevant region. Here, the third deep neural network model may be a supervised learning-based model trained using third training data, where the input consists of the day-ahead system marginal price (DA SMP), the real-time system marginal price (RT SMP), the day-ahead forecasted power generation (DA GEN), and the real-time forecasted power generation (RT GEN) of a relevant region and the label consists of day-ahead bid quantity for each time period in the relevant region.

The processor 160 may train the initially configured set third deep neural network model using the labeled third training data in a supervised learning manner. Here, the initially configured set third deep neural network model is an initial model designed to be configured as a model capable of forecasting the day-ahead bid quantity for each time period in the relevant region from the day-ahead system marginal price (DA SMP), the real-time system marginal price (RT SMP), the day-ahead forecasted power generation (DA GEN), and the real-time forecasted power generation (RT GEN) of the relevant region, and its parameter values may be set to arbitrary initial values. As the initial model is trained using the aforementioned third training data, its parameter values are optimized, enabling it to be completed as a third prediction model capable of accurately predicting the day-ahead bid quantity for each time period in the relevant region based on the day-ahead system marginal price (DA SMP), the real-time system marginal price (RT SMP), the day-ahead forecasted power generation (DA GEN), and the real-time forecasted power generation (RT GEN) of the relevant region.

In an embodiment, the bidding strategy formulation apparatus 100 may be implemented as an independent server, or the bidding strategy formulation function provided by the bidding strategy formulation apparatus 100 may be implemented as an application to be installed on a user terminal (not shown). The user terminal may access the bidding strategy formulation application and/or bidding strategy formulation site provided by the bidding strategy formulation apparatus 100 to receive a bidding strategy formulation service. In an embodiment, the bidding strategy formulation apparatus 100 may further include a communication module (not shown) to communicate with the user terminal and an external device.

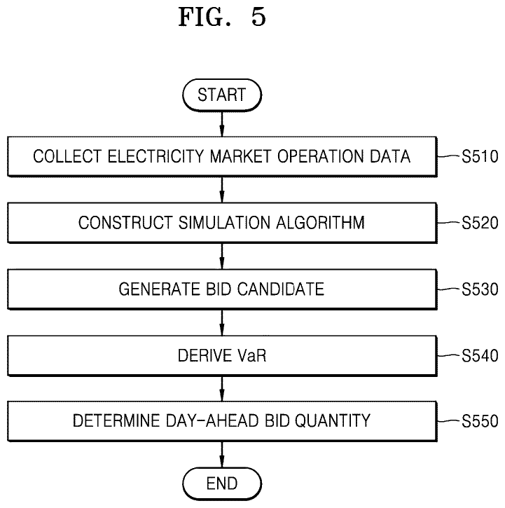

FIG. 5 is a flowchart illustrating a method for formulating a bidding strategy based on photovoltaic power generation according to an embodiment. In the following description, redundant descriptions overlapping with the descriptions of FIGS. 1 to 4 will not be reiterated. The method for formulating a bidding strategy based on photovoltaic power generation according to the embodiment will be described on the assumption that the method is performed by the processor 160 with the help of the peripheral components of the bidding strategy formulation apparatus 100.

Referring to FIG. 5, in step S510, the processor 160 may collect electricity market operation data including at least one of the day-ahead system marginal price (DA SMP), the real-time system marginal price (RT SMP), the day-ahead forecasted power generation (DA GEN), and the real-time forecasted power generation (RT GEN).

In step S520, the processor 160 may construct a simulation algorithm based on the electricity market operation data. When constructing the simulation algorithm, the processor 160 may construct a first simulation algorithm (SMP DA simulation) based on the day-ahead system marginal price (DA SMP). The processor 160 may construct a second simulation algorithm based on the execution result of the first simulation algorithm (SMP DA simulation), the day-ahead system marginal price (DA SMP), the real-time system marginal price (RT SMP), and the number of bid candidates. The processor 160 may construct a third simulation algorithm based on the day-ahead forecasted power generation (DA GEN), the real-time forecasted power generation (RT GEN), and the number of bid candidates.

In step S530, the processor 160 may generate at least one bid candidate from at least one power generation forecast scenario derived based on the day-ahead forecasted power generation (DA GEN). When generating the bid candidate, the processor 160 may load the day-ahead forecasted power generation (DA GEN), which includes power generation for each time period throughout a day. The processor 160 may receive a forecast range for power generation and a bid candidate extraction interval. The processor 160 may generate a power generation forecast scenario by applying the forecast range to the day-ahead forecasted power generation (DA GEN). The processor 160 may extract at least one bid candidate corresponding to the extraction interval from the power generation forecast scenario. The processor 160 may obtain the time period and forecasted power generation that are matched to the at least one extracted bid candidate.

In step S540, the processor 160 may derive VaR satisfying a preset confidence level, based on the simulation algorithms and the bid candidate. When deriving the VaR, the processor 160 may calculate a day-ahead forecasted revenue (Gen DA Revenue) using a first risk prediction algorithm, which is generated based on the time period and forecasted power generation that are matched to the bid candidate, the number of bid candidates, and the first simulation algorithm (SMP DA simulation). The processor 160 may calculate a real-time forecasted revenue (Gen RT settlement) using a second risk prediction algorithm, which is generated based on the time period and forecasted power generation that are matched to the bid candidate, the number of bid candidates, the second simulation algorithm (SMP RT simulation), and the third simulation algorithm (GEN RT simulation). The processor 160 may calculate the total profit using a third risk prediction algorithm, which is generated based on the day-ahead forecasted revenue (Gen DA Revenue) and the real-time forecasted revenue (Gen RT Settlement). The processor 160 may calculate a loss using a fourth risk prediction algorithm generated based on the total profit. The processor 160 may derive the loss satisfying a preset confidence level as VaR based on the results of calculating the loss.

In step S550, the processor 160 may determine the forecasted power generation satisfying preset conditions as the day-ahead bid quantity, based on the result of deriving the VaR. When determining the day-ahead bid quantity, the processor 160 may sort the results of deriving VaR in chronological order (by hour) and identify the bid candidate with the minimum VaR for each time period based on the VaR derived for each time period. The processor 160 may obtain the forecasted power generation corresponding to the bid candidate with the minimum VaR for each time period, and determine the result of aggregating the forecasted power generation as the day-ahead bid quantity.

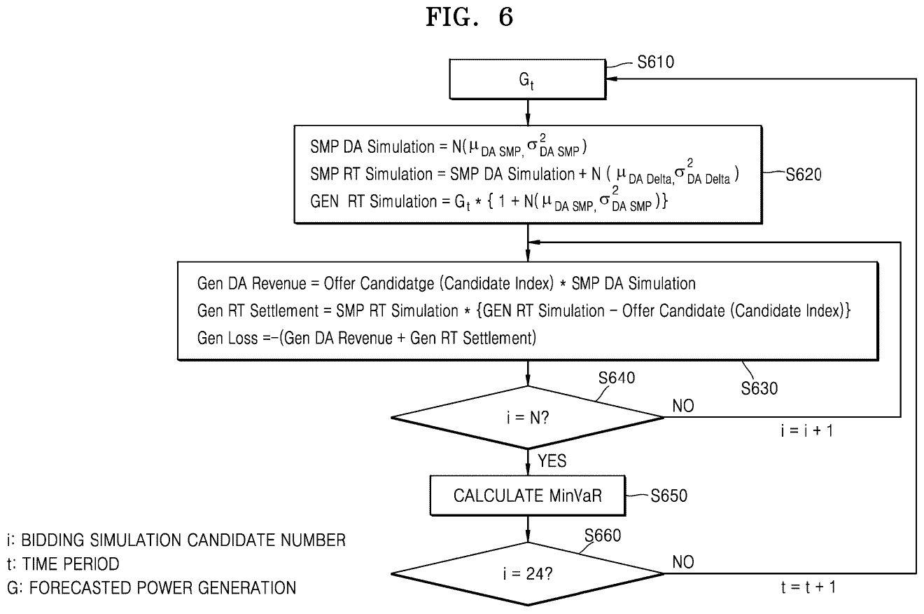

FIG. 6 is a flowchart illustrating the VaR derivation and bid quantity determination process in the method for formulating a bidding strategy based on photovoltaic power generation, as shown in FIG. 5. In the following description, redundant descriptions overlapping with the descriptions of FIGS. 1 to 5 will not be reiterated. The method for formulating a bidding strategy based on photovoltaic power generation according to the embodiment will be described on the assumption that the method is performed by the processor 160 with the help of the peripheral components of the bidding strategy formulation apparatus 100.

Referring to FIG. 6, in steps S610 and S620, the processor 160 may apply the bid candidate matched to a forecasted power generation Gₜ of a given time period to the first to third simulation algorithms to generate first to third simulation results.

In an embodiment, the first simulation algorithm (SMP DA simulation) may be constructed based on the day-ahead system marginal price (DA SMP) as expressed in Equation 1, or may be configured as expressed in Equation 8 below by modifying Equation 1.

$$S M P D A Simulation = N ( {μ}_{DA SMP} , {σ}_{DA SMP}^{2} ) \qquad [ Equation 8 ]$$

In an embodiment, the second simulation algorithm (SMP RT simulation) may be constructed based on the execution result of the first simulation algorithm (DA SMP simulation), the day-ahead system marginal price (DA SMP), and the real-time system marginal price (RT SMP), as expressed in Equation 2, or may be configured as expressed in Equation 9 by modifying Equation 2.

$$S M P R T Simulation = S M P D A Simulation + N ( {μ}_{DA Delta} , {σ}_{SMP Delta}^{2} ) \qquad [ Equation 9 ]$$

In an embodiment, the third simulation algorithm (Gen RT simulation) may be constructed based on the day-ahead forecasted power generation (DA GEN) and the real-time forecasted power generation (RT GEN), as expressed in Equation 3, or may be configured as expressed in Equation 10 by modifying Equation 3.

$$Gen R T Simulation = {G}_{t} * \{ 1 + N ( {μ}_{DA SMP} , {σ}_{DA SMP}^{2} ) \} \qquad [ Equation 10 ]$$

In step S630, the processor 160 may derive VaR satisfying a preset confidence level, based on the first to fourth risk prediction algorithms.

In an embodiment, the processor 160 may calculate the day-ahead forecasted revenue (Gen DA Revenue) using the first risk prediction algorithm, as defined in Equation 4. The processor 160 may calculate the real-time forecasted revenue (Gen RT settlement) using the second risk prediction algorithm, as defined in Equation 5. The processor 160 may calculate the total profit (Gen Profit) using the third risk prediction algorithm, as defined in Equation 6. The processor 160 may calculate the loss (Gen Loss) using the fourth risk prediction algorithm, as defined in Equation 7. The processor 160 may derive VaR by extracting the loss (Gen Loss) that satisfies a preset confidence level from the results of calculating the loss (Gen Loss).

In step S640, the processor 160 may determine whether the number of bid candidates is a preset number (N), and in case that the preset number is not met, the processor 160 may increment the number of bid candidates by one and derive VaR.

In step S650, when the number of bid candidates is the present number (N), the processor 160 may extract the minimum VaR from the results of deriving the VaR, which corresponds to the loss (Gen Loss) that satisfies the preset confidence level.

In step S660, the processor 160 may determine whether the current time is 24:00, and when the current time is not 24:00, the processor 160 may increment the current time by one hour and apply the forecasted power generation Gt matched to the bid candidate at the updated time to the first to third simulation algorithms to generate the first to third simulation results.

According to the disclosure, it is possible to more accurately assess and manage the forecast uncertainty of photovoltaic power generation, thereby reducing risks in the electricity market, minimizing the likelihood of financial losses, and assisting in the establishment of a more stable power supply plan.

Additionally, a foundation for proactively responding to price volatility in the electricity market and designing efficient bidding strategies is established, ultimately benefiting both power suppliers and consumers.

The embodiments of the disclosure described above may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a compact disk ROM (CD-ROM) or a digital video disc (DVD), a magneto-optical medium, such as a floptical disk, and a hardware device specially configured to store and execute program instructions, such as ROM, RAM, or flash memory.

Meanwhile, the computer program may be specially designed and configured for the disclosure or may be well-known to and be usable by those of ordinary skill in the art of computer software. Examples of the computer program may include not only machine code, such as code made by a compiler, but also high-level language code that is executable by a computer by using an interpreter or the like.

The term “the” and other demonstratives similar thereto in the specification of the disclosure (especially in the following claims) should be understood to include a singular form and plural forms. Furthermore, recitation of ranges of values herein are merely intended to serve as a shorthand method of referring individually to each separate value falling within the range, unless otherwise indicated herein, and each separate value is incorporated into the specification as if it were individually recited herein.

The steps or operations of the methods described herein may be performed in any suitable order unless otherwise indicated herein or otherwise clearly contradicted by context. The disclosure is not limited to the described order in which the steps or operations are described. The use of any and all examples, or exemplary language (e.g., “and the like”) provided herein, is intended merely to better illuminate the disclosure and does not pose a limitation on the scope of the disclosure unless otherwise claimed. In addition, various modifications, combinations, and adaptations will be readily apparent to those skilled in this art without departing from the following claims and equivalents thereof.

Accordingly, the spirit of the disclosure should not be limited to the above-described embodiments, and all modifications and variations which may be derived from the meanings, scopes and equivalents of the claims should be construed as failing within the scope of the disclosure.

What is claimed is:

1. A method for formulating a bidding strategy performed by a processor of an apparatus for formulating a bidding strategy, the method comprising:
collecting electricity market operation data including at least one of a day-ahead system marginal price, a real-time system marginal price, a day-ahead forecasted power generation made on a previous day for a next day, and a real-time forecasted power generation;
constructing a simulation algorithm based on the electricity market operation data;
generating at least one bid candidate from at least one power generation forecast scenario derived based on the day-ahead forecasted power generation made on a previous day for a next day;
deriving value at risk (VaR) based on the simulation algorithm and the bid candidate; and
determining forecasted power generation that satisfies a preset condition as day-ahead bid quantity based on a result of deriving the VaR.

2. The method of claim 1, wherein the constructing of the simulation algorithm comprises:
constructing a first simulation algorithm based on the day-ahead system marginal price;
constructing a second simulation algorithm based on an execution result of the first simulation algorithm, the day-ahead system marginal price, and the real-time system marginal price; and
constructing a third simulation algorithm based on the day-ahead forecasted power generation made on a previous day for a next day and the real-time forecasted power generation.

3. The method of claim 2, wherein the generating of the at least one bid candidate comprises:
loading the day-ahead forecasted power generation made on a previous day for a next day, which includes power generation for each time period throughout a day;
receiving a forecast range for power generation and a bid candidate extraction interval;
generating a power generation forecast scenario by applying the forecast range to the day-ahead forecasted power generation made on a previous day for a next day;
extracting at least one bid candidate corresponding to the extraction interval from the power generation forecast scenario; and
obtaining a time period and forecasted power generation that are matched to the at least one bid candidate.

4. The method of claim 3, wherein the deriving of the VaR comprises:
calculating a day-ahead forecasted revenue using a first risk prediction algorithm, which is generated based on the time period and forecasted power generation that are matched to the bid candidate, the number of bid candidates, and the first simulation algorithm;
calculating a real-time forecasted revenue using a second risk prediction algorithm, which is generated based on the time period and forecasted power generation that are matched to the bid candidate, the number of bid candidates, the second simulation algorithm, and the third simulation algorithm;
calculating total profit using a third risk prediction algorithm generated based on the day-ahead forecasted revenue and the real-time forecasted revenue;
calculating a loss using a fourth risk prediction algorithm generated based on the total profit; and
deriving a loss satisfying the preset confidence level as VaR, based on results of calculating the loss.

5. The method of claim 1, wherein the determining of the day-ahead bid quantity comprises:
sorting results of deriving the VaR in chronological order (by hour);
identifying a bid candidate with minimum VaR based on the VaR derived for each time period;
obtaining forecasted power generation corresponding to the bid candidate with the minimum VaR for each time period; and
determining a result of aggregating the forecasted power generation as the day-ahead bid quantity.

6. A non-transitory computer readable recording medium on which a computer program configured to allow a computer to execute the method of claim 1 is stored.

7. An apparatus for formulating a bidding strategy, comprising:
at least one processor; and
at least one memory operably connected to the processor;
wherein the at least one processor is further configured to
collect electricity market operation data including one or more of a day-ahead system marginal price, a real-time system marginal price, a day-ahead forecasted power generation made on a previous day for a next day, and a real-time forecasted power generation;
construct a simulation algorithm based on the electricity market operation data,
generate at least one bid candidate from at least one power generation forecast scenario derived based on the day-ahead forecasted power generation made on a previous day for a next day,
derive value at risk (VaR) based on the simulation algorithm and the bid candidate, and
determine forecasted power generation satisfying a preset condition as day-ahead bid quantity, based on a result of deriving the VaR.

8. The apparatus of claim 7, wherein the at least one processor is further configured to
construct a first simulation algorithm based on the day-ahead system marginal price, when constructing the simulation algorithm,
construct a second simulation algorithm based on an execution result of the first simulation algorithm, the day-ahead system marginal price, and the real-time system marginal price, and
construct a third simulation algorithm based on the day-ahead forecasted power generation and the real-time forecasted power generation.

9. The apparatus of claim 8, wherein the at least one processor is further configured to
load the day-ahead forecasted power generation, which includes power generation for each time period throughout a day, when generating the bid candidate,
receive a forecast range for power generation and a bid candidate extraction interval,
generate a power generation forecast scenario by applying the forecast range to the day-ahead forecasted power generation,
extract at least one bid candidate corresponding to the extraction interval from the power generation forecast scenario, and
obtain a time period and forecasted power generation that are matched to the at least one extracted bid candidate.

10. The apparatus of claim 9, wherein the at least one processor is further configured to
calculate a day-ahead forecasted revenue using a first risk prediction algorithm, which is generated based on the time period and forecasted power generation that are matched to the bid candidate, the number of bid candidates, and a first simulation algorithm, when deriving the VaR,
calculate a real-time forecasted revenue using a second risk prediction algorithm, which is generated based on the time period and forecasted power generation that are matched to the bid candidate, the number of bid candidates, the second simulation algorithm, and the third simulation algorithm;
calculate total profit using a third risk prediction algorithm generated based on the day-ahead forecasted revenue and the real-time forecasted revenue,
calculate a loss using a fourth risk prediction algorithm generated based on the total profit, and
derive a loss satisfying the preset confidence level as the VaR, based on results of calculating the loss.

11. The apparatus of claim 7, wherein the at least one processor is further configured to
sort results of deriving the VaR in chronological order (by hour) when determining the day-ahead bid quantity,
identify a bid candidate with the minimum VaR based on the VaR derived for each time period,
obtain forecasted power generation matched to the bid candidate with the minimum VaR for each time period, and
determine a result of aggregatin the forecasted power generation as the day-ahead bid quantity.
